(19) United States
(12) Patent Application Publication
(10) Pub. No.: US 2012/0177934 A1
(43) Pub. Date: Jul. 12, 2012

(54) METHOD FOR THE PRODUCTION OF STRETCHABLE ELECTRODES

(75) Inventors: Stephanie Vogel, Langenfeld (DE); Joachim Wagner, Koln (DE); Christel Fussangel, Neuss (DE)

(73) Assignee: Bayer MaterialScience AG Law and Patents, Leverkusen (DE)

(21) Appl. No.: 13/384,300

(22) PCT Filed: Jan. 14, 2010
(86) PCT No.: PCT/EP2010/004283

§ 371 Date: Mar. 28, 2012

(30) Foreign Application Priority Data
Jul. 22, 2009 (EP) 09009472.3

(51) Int. Cl. B32B 15/04; H01B 1/24; B32B 19/00; B82Y 15/00; B82Y 30/00; B82Y 40/00

(52) U.S. Cl. 428/457; 252/511; 428/688; 977/773; 977/895; 977/832; 977/932; 977/742; 977/842; 977/750; 977/752; 977/734; 977/762; 977/953

(57) ABSTRACT

The invention relates to a method for producing stretchable electrodes, where electrically conductive carbon particles, especially carbon nanotubes, are introduced into a coating comprising an elastomer. In said method, a preparation of non-aggregated carbon particles having an average particle diameter ranging from=0.3 nm to=3000 nm in a solvent acts upon a coating comprising an elastomer. The solvent can cause a coating comprising an elastomer to swell. The duration of the action is calculated so as to be insufficient to dissolve the elastomer. Optionally, another electrically conductive layer is applied. The invention also relates to a stretchable electrode obtained in said manner and to the use thereof.

The present invention relates to a process for producing extensible electrodes. Here, electrically conductive carbon particles are introduced into a surface layer comprising an elastomer. These carbon particles can be, in particular, carbon nanotubes. The invention further relates to an extensible electrode which can be obtained according to the invention and also the use of such an electrode.

Carbon nanotubes (CNTs) are known for their extraordinary properties. Thus, for example, their strength is about 100 times that of steel, their thermal conductivity is about twice that of diamond, their thermal stability extends up to 2800° C. under reduced pressure and their electrical conductivity can be a multiple of the conductivity of copper. However, these structure-related characteristics can be obtained on a molecular level only when carbon nanotubes can be successfully distributed homogeneously and a very large contact area between the tubes and the medium can be established, i.e. the nanotubes are compatible with the medium and can thus be stably dispersed. As regards electrical conductivity, it is also necessary to form an optionally homogeneous network of tubes in which these, in the ideal case, contact one another only at the ends. Here, the carbon nanotubes should ideally be present as isolated individual nanotubes, i.e. agglomerate-free, not be aligned and be present in a concentration at which such a network can be formed, which is reflected in the step increase in the electrical conductivity as a function of the concentration of carbon nanotubes (percolation limit).

Electrically conductive materials whose conductive properties change only slightly, if at all, under mechanical stress can be used for applications, for example, under the catchword “intelligent clothing”, flexible display elements, extensible electric circuits, implants, prostheses, microelectro-mechanical systems (MEMS) and dielectric elastomer actuators. In such applications, mechanical elongations can range from less than 5% to over 200%.

The hitherto customary approach for producing extensible electrodes has been restricted to the choice of an elastomer which withstands the required mechanical stresses and subsequent treatment thereof with electrically conductive materials. These materials can be, for example, conductive carbon blacks or metal powders which are embedded in a liquid matrix and painted onto the elastomer surface. After evaporation of the solvent, a thin layer of the conductive material remains on the electrode. A discussion of various methods may be found in the publication by S. R. Ghaffarian et al. in Journal of Optoelectronics and Advanced Materials 2007, 9, 3585-3591.

The problems associated with this method are obvious. The electrode can deteriorate as a result of mechanical stress and has fundamentally different mechanical extensibilities than the carrier elastomer. The latter leads to the less elastic electrode rupturing earlier under mechanical stress.

Such cracks represent breaks in the conductivity and can overall lead to a loss in the function of such an extensible two-layer electrode. Although the variant of applying the electrically conductive material to a preelongated elastomer enables a few percent of elongation of the electrode to be gained in the range of the preelongation without loss of conductivity, coating of an elastomer with an electrode material such as conductive silver always brings about an undesirable increase in the E modulus and thus leads to a deterioration in the mechanical properties of the extensible electrode. Depending on the application and materials, this can even lead to the stiffening of the carrier elastomer exceeding the tolerance range even before the percolation limit of the electrode material has been reached.

In a more recent study, E. Smela et al. in the publication Advanced Materials 2007, 19, 2629-2633, have reported, for example, that extensible electrodes can be obtained by mixing of a metal salt with a radiation-curable elastomer precursor compound, curing and reduction by means of a reduction solution.

Two aspects have to be taken into account for successful processing of carbon nanotubes if a material is, for example, to be made electrically conductive by their use: the complete breaking-up and debundling of carbon nanotube agglomerates and suppression of the strong tendency of carbon nanotubes to reagglomerate (in one and the same medium during the aging process or during processing of such a dispersion to give the finished material). These difficulties associated with the processing of carbon nanotubes are due to the hydrophobic character of the carbon nanotube surface and the high aspect ratio of this pseudo-one-dimensional structure.

If the carbon nanotubes are to be prevented from finding an energy minimum in their alternate arrangement in the form of bundles and/or agglomerates, their compatibility with the surrounding medium has to be increased. Here, it should be noted that chemical, covalent functionalization of carbon nanotubes can actually improve their compatibility with the polymer medium. This is reflected, for example, in an increased (thermal) long-term stability and the absence of reagglomeration. However, this surface modification also interrupts the delocalized π electron system of the tubes and thus reduces the electrical conductivity of each individual tube as a function of the degree of functionalization.

The noncovalent functionalization of carbon nanotubes by means of, for example, dispersing additives represents an alternative to chemical, covalent modification and making the tubes compatible with the medium. However, it has to be taken into account that this approach requires fresh optimization in respect of the chemistry and the concentration of the respective dispersing additive for each new medium regardless of whether it is an elastomer raw material or an elastomer formulation and can never provide a universal solution.

Finally, it should be noted that any processing of fillers, including carbon nanotubes, also incurs the risk that a new property, for example the electrical conductivity, can possibly be achieved but at the same time a number of other, for example mechanical, properties can be worsened. This is especially critical when carbon nanotubes are incorporated into unfoamed, compact and/or elastic systems. Residual agglomerates which have not been able to be broken up completely during the dispersing process represent, for example in a compact shaped part, a preferential rupture point. Mechanical properties such as the impact toughness and rupture strength can be impaired by such agglomerates. According to the previous prior art, making a compact material electrically conductive by addition of carbon nanotubes would require the carbon nanotubes to be homogeneously distributed over the entire volume of the material so that the percolation limit is exceeded and at the same time no residual agglomerates are present.

This procedure very often founders on the dramatic viscosity increases which are required to exceed the percolation limit due to the carbon nanotube concentrations necessary. Furthermore, reagglomeration of homogeneously dispersed carbon nanotubes during elastomer processing cannot be ruled out by means of this method and cannot readily be prevented.

On the subject of incorporating carbon nanotubes into (thermoplastic) polyurethanes, the literature contains numerous studies in which the finished polymer is firstly dissolved completely in an organic solvent, the nanotubes are subsequently dispersed in this polymer solution and the resulting nanotube dispersion based on polyurethane/solvent is drawn to form a film or poured into a mold. In this process, the last step is always the time-consuming evaporation of the large amounts of solvent.

A possible alternative is to provide not the entire polymer matrix but only a material layer directly adjoining the surface with the particles. Such a procedure would be desirable in order to avoid the abovementioned disadvantages of solvent consumption, the increasing viscosity and the adverse effects on the mechanics of the polymer matrix.

WO 2008/150867 A2 discloses a process for embedding particles in a substrate. In this process, a fluid which has a population of particles having at least one characteristic dimension in the range from about 0.1 nm to about 1 cm is applied to at least part of the substrate. Application is carried out in such a way that the substrate softens to such a degree that a number of particles are at least partly embedded in the softened region of the substrate. At least part of the substrate is subsequently hardened so that at least one particle is securely embedded in the substrate. It is stated that heating can aid the embedding of particles. The embedding of carbon particles such as carbon nanotubes in elastomers is not specifically described. The examples in this patent application concern the embedding of silver nanoparticles in polyvinyl chloride.

Consequently, there continues to be a need for improved processes for producing extensible electrodes having conductive carbon particles incorporated into the elastomer surface. It would also be desirable to have production processes for such functionalized elastomer surfaces which do not completely lose their electrical conductivity on repeated elongation and destressing.

The invention therefore proposes a process for producing extensible electrodes having a surface layer comprising electrically conductive carbon particles, which comprises the steps:

(A) provision of an elastomer which has a glass transition temperature T₅ of from ≧−130° C. to ≦0° C. and in which the stress σ does not decrease with increasing elongation;

(B) provision of a preparation of unaggregated carbon particles having an average particle diameter of from ≧0.3 nm to ≦3000 nm in a solvent which is able to bring about swelling of a surface layer of the elastomer;

(C) contacting of the surface layer of the elastomer with the preparation of the carbon particles;

(D) acting of the preparation of the carbon particles on the surface layer of the elastomer for a time which is insufficient to bring the elastomer into solution; and

(E) ending of the action of the preparation of the carbon particles on the surface layer of the elastomer.

Electrically conductive particles are, for the purposes of the present invention, firstly all particles composed of a material which is not an insulator. Substances which have an electrical conductivity of less than 10⁻⁸ S/m are typically referred to as insulators. The particles are introduced into a surface layer comprising an elastomer, which means that not necessarily only the surface itself is provided with the particles but the material directly below the surface also takes up the particles. Consequently, the term surface layer as used for the purposes of the invention means, in contrast to a two-dimensional surface, a three-dimensional layer of material which has the surface as one of its boundaries. The surface layer is distinguished from the interior of the object concerned at least in that it contains these electrically conductive particles.

In step (A), an elastomer is provided. For the purposes of the present invention, elastomers are polymers which have a stable shape but can be elastically deformed. According to the invention, the elastomer has a glass transition temperature T_{g} of from ≧−130° C. to ≦0° C. The glass transition temperatures can be determined in accordance with the standard DIN EN ISO 6721-1 and can also be in the range from ≧−80° C. to ≦−10° C. or from ≧−78° C. to ≦−30° C. Furthermore, the invention provides for the stress σ in the elastomer not to decrease with increasing elongation. This refers to the behavior of the stress σ at the intended use temperature of the electrode. This means, in particular, that in a stress-strain graph, the curve for the stress σ does not have a local maximum. In other words, the elastomers do not display a yield point in the stress-strain curve. Particularly suitable elastomers have a stress σ which increases progressively with increasing elongation without displaying a yield point in the stress-strain curve. Preference is given to the stress σ not decreasing with increasing elongation in the elastomer.

Suitable elastomers can, without being restricted thereto, have a Shore A hardness in accordance with ISO 868 of from ≧20 to ≦100. The polymers can deform elastically under tensile and compressive stress and have tensile strengths in accordance with DIN 53 504 in the range from ≧10 kPa to ≦60 MPa. After stressing, they largely return to their original, undeformed shape. Good elastomers display only a small residual elongation and no appreciable creep under long-term mechanical load. The creep tendency in accordance with DIN EN 10 291 is preferably ≦20% and more preferably ≦5%.

Step (B) comprises provision of a preparation of unaggregated carbon particles. This means that the particles are present as separate individual particles in the solvent or at least have such a low degree of aggregation that the preparation is stable. In a stable preparation, no flocculation or precipitation of the carbon particles occurs during storage at room temperature for a period of at least one day, preferably one week or four weeks. To produce such a preparation, the aggregates of the carbon particles which are present can be broken up by input of energy, for example by means of ultrasound, milling processes or high shear forces. Finally, the solvent is selected so that it can both form the preparation of the carbon particles and swell the elastomer surface.

The average particle diameter can also be in the range from ≧1 nm to ≦1000 nm or from ≧3 nm to ≦100 nm. It can be determined, for example, by means of scanning electron microscopy or dynamic light scattering.

The solvent can be an aqueous or nonaqueous solvent. In the latter case, preference is given to a polar, aprotic solvent. In this way, the solvent can readily interact with soft segment domains in the elastomer. The term “nonaqueous” means that no additional water has been added to the solvent, but includes the industrially unavoidable traces of water, for example up to an amount of ≦5% by weight, preferably ≦3% by weight and more preferably ≦1% by weight.

If the solvent is an aqueous solvent, the carbon particles can be deagglomerated and kept in suspension by addition of surfactants or other surface-active substances.

The carbon particles can be present in the solvent in a concentration of, for example, from ≧0.01% by weight to ≦20% by weight, from ≧0.1% by weight to ≦15% by weight or from ≧0.04% by weight to ≦5% by weight.

The contacting of the surface layer comprising an elastomer with the preparation of the carbon particles in step (C) is naturally carried out over the surface of the elastomer.

In the subsequent step (D), the preparation of the carbon particles acts on the surface layer. Without wishing to be tied to a theory, it is assumed that the surface of the elastomer is swelled by the solvent, pores are formed in the surface layer and carbon particles can migrate into these pores. In the case of aqueous or water-containing solvents, swelling of the elastomer is promoted when hydrophilic domains are present in the polymer. The particles can, for example, penetrate into the surface layer to a depth of ≦10 μm, ≦1 μm or ≦0.3 μm.

The time for which the preparation of the carbon particles acts on the surface layer is selected so that the elastomer of the surface layer does not go into solution. Included here are industrially unavoidable dissolution processes in which, for example, ≦1% by weight, ≦0.1% by weight or ≦0.01% by weight, of the elastomer go into solution. However, the process of the invention is not a process in which the polymer is firstly homogeneously dissolved and the finished particles in the matrix are then obtained by removal of the solvent from the solution of the polymer with nanoparticles. Rather, the time for which the preparation of the carbon particles acts is selected so that swelling of the polymer surface can take place. Examples of suitable times of action are from ≧1 second to ≦360 minutes, preferably from ≧1 minute to ≦90 minutes, more preferably from ≧3 minutes to ≦10 minutes.

Finally, step (E) comprises the ending of the action of the preparation of the carbon particles on the surface layer. Thus, the preparation of the carbon particles is separated again from the surface layer. The surface layer can subsequently be rinsed to remove adhering preparation. This can be carried out, inter alia, by removing the elastomer object with the surface layer to be modified from a dipping bath. The object can then be, for example, rinsed with acetone.

Step (E) is advantageously followed by a drying step in which the solvent present in the swollen surface layer is removed, resulting in the pores in the elastomer closing and the carbon particles being enclosed in the polymer.

The process of the invention makes it possible to provide the surface layer of an elastomer object with an electrically conductive surface in a targeted manner in order to produce an extensible electrode. Owing to the elastomer which is functionalized in the process being selected according to the invention, the electrode is also suitable for cyclic stresses. In the process, the shape of the object is not destroyed by dissolution, so that finished shaped parts can also be treated. Since the particles are concentrated in the region close to the surface of the object, a smaller overall amount is required to obtain an electrically conductive elastomer surface. Finally, it is not necessary to remove large amounts of solvents in order to obtain the finished modified polymer, in contrast to dissolution-based processes. It is also possible to keep the concentration of the carbon particles in a range in which no industrially disadvantageous increase in viscosity occurs.

A further advantageous aspect of the process of the invention for producing extensible electrodes is the treatment of elastomer moldings which are to be surface-coated by electrostatic powder coating or are to be electroplated. The electrically conductive particles in the surface layer here ensure improved electrostatic powder application. A further use concerns the treatment of elastomer moldings for preparation for electrophoretic coating. It is also possible to obtain conductive electrode materials or elastic capacitors. Furthermore, electronic components or cable sheathing can be provided with an antistatic coating.

In one embodiment of the process of the invention, the process further comprises the step:

(F) application of an additional electrically conductive layer to the surface layer comprising electrically conductive carbon particles obtained in steps (B) to (E), where the additional electrically conductive layer obtained breaks up or ruptures on elongation of the surface layer before the latter does.

The additional electrically conductive layer in step (F) can be, for example, a conductive surface coating, a conductive paste, a metal layer or a layer of an electrically conductive polymer. Examples of metals are gold, silver, copper and/or tin. Examples of electrically conductive polymers are polythiophenes, in particular poly(3,4-ethylenedioxythiophene) which is usually referred to as PEDOT or PEDT. The metals can be applied, for example, by chemical deposition from the gas phase, physical deposition from the gas phase or sputtering. Preference is here given to sputtering-on of gold. The application of the electrically conductive polymers can be carried out by means of a polymer solution, followed by evaporation of the solvent. Further possible materials for the additional layer are indium-tin oxide (ITO), fluorine-doped tin(IV) oxide (FTO), aluminum-doped zinc oxide (AZO) and/or antimony-doped tin(IV) oxide (ATO).

The additional electric layer can have, without being restricted thereto, a thickness of from ≧10 nm to ≦10 μm or from ≧20 nm to ≦1 μm.

The material of the additional electrically conductive layer is selected so that the additional layer breaks up or ruptures first on elongation of the surface layer. It is advantageous here that the electrical conductivity of the overall system does not break down abruptly due to contact of the broken-up or ruptured coating with the surface layer comprising carbon particles but instead is maintained to a certain degree. In other words, although the power density of an extensible electrode decreases with time as a result of the stress, it does not cease completely. This behavior is particularly advantageous when the elastomer is subjected to cyclic elongation and destressing and electrical conductivity is required over the entire time.

In a preferred embodiment of the process of the invention, the acting of the preparation of the carbon particles on the surface layer of the elastomer in step (D) takes place using ultrasound and/or heat. The energy input brought about by ultrasound and/or heating firstly counters the formation of particle aggregates and thus makes it possible to obtain higher particle concentrations in the solution. Furthermore, the introduction of the particles into the elastomer surface layer is accelerated. In the case of ultrasound, the frequency is advantageously from ≧20 kHz to ≦20 MHz and, independently thereof, the power density in the solvent is from ≧1 W/1 to ≦200 W/1. In the case of heating during action of the preparation of the carbon particles on the surface layer, the temperature can be, for example, from ≧30° C. to ≦200° C., preferably from ≧40° C. to ≦150° C.

It is possible for the carbon particles used not to be covalently functionalized further on the surface after the production thereof. This means that the particles bear no additional functional groups which are covalently attached by means of further reaction steps on their surface. In particular, the use of oxidants such as nitric acid, hydrogen peroxide, potassium permanganate and sulfuric acid or a possible mixture of these agents for functionalization of the carbon particles is avoided. An advantage of the use of noncovalently functionalized particles is that the π electron system of the surface is not disrupted and can therefore continue to contribute to the electrical conductivity.

In a further embodiment of the process of the invention, the carbon particles are selected from the group consisting of carbon nanotubes, single-wall carbon nanotubes, multiwall carbon nanotubes, carbon nanohorns, carbon nanoonions, fullerenes, graphite, graphene, carbon fibers, carbon black and conductive carbon black. These particles can not only increase the electrical conductivity but also improve mechanical properties of the surface layer, for example elasticity and impact toughness.

For the purposes of the invention, carbon nanotubes include all single-wall or multiwall carbon nanotubes of the cylinder type, scroll type, multiscroll type or having an onion-like structure. Preference is given to using multiwall carbon nanotubes of the cylinder type, scroll type, multiscroll type or mixtures thereof. It is advantageous for the carbon nanotubes to have a ratio of length to external diameter of ≧5, preferably ≧100.

In contrast to the abovementioned known carbon nanotubes of the scroll type having only one continuous or interrupted graphene layer, there are also carbon nanotube structures which consist of a plurality of graphene layers which are combined to form a stack and rolled up. This is referred to as the multiscroll type. These carbon nanotubes are described in DE 10 2007 044031 Al, which is fully incorporated by reference. This structure is related to the carbon nanotubes of the single scroll type in the same way as the structure of multiwall cylindrical carbon nanotubes (cylindrical MWNT) is related to the structure of the single-wall cylindrical carbon nanotubes (cylindrical SWNT).

Unlike the case of the onion-like structures, the individual graphene or graphite layers in these carbon nanotubes obviously run, viewed in cross section, continuously from the center of the carbon nanotubes to the outer edge without interruption. This can, for example, allow improved and faster intercalation of other materials into the tube framework, since more open edges are available as entry zone for the intercalates compared to carbon nanotubes having a simple scroll structure (Carbon 1996, 34, 1301-3) or CNTs having an onion-like structure (Science 1994, 263, 1744-7).

The carbon particles are preferably multiwall carbon nanotubes which have a diameter of from ≧3 nm to ≦100 nm and are not covalently functionalized. The diameter is here based on the average diameter of the nanotubes. It can also be in the range from ≧5 nm to ≦80 nm and advantageously from ≧6 nm to ≦60 nm. The length of the nanotubes is initially not limited. However, it can, for example, be in the range from ≧1 μm to ≦100 μm and advantageously from ≧10 μm to ≦30 μm.

In a further embodiment of the process of the invention, the solvent is selected from the group consisting of methanol, ethanol, isopropanol, butanol, ethylene glycol, propylene glycol, butylene glycol, glycerol, hydroquinone, acetone, ethyl acetate, trichloroethylene, trichloroethane, trichloromethane, methylene chloride, cyclohexanone, N,N-dimethylformamide, dimethyl sulfoxide, tetrahydrofuran, N-methyl-2-pyrrolidone, benzene, toluene, chlorobenzene, styrene, polyester polyols, polyether polyols, methyl ethyl ketone, ethylene glycol monobutyl ether, diethylene glycol, mixtures of the abovementioned solvents with one another and mixtures of the abovementioned solvents with water.

These solvents combine, in a particular way, the ability to form low-aggregate or aggregate-free solutions with the carbon particles and at the same time lead, when the polymer is appropriately selected, to swelling of the elastomer surface. Mixtures of the abovementioned solvents include cases in which the solvent is also soluble in water in the desired proportion by mass.

The contacting of the surface layer comprising an elastomer with the preparation of the carbon particles can, inter alia, be carried out by dipping, application, printing, painting, spraying and/or pouring-on. Objects can, for example, easily be treated by dipping in a dipping bath. A continuous process for producing a polymer film treated in this way can also easily be realized. Printing onto elastomer objects, for example by screen printing, allows the production of electrically conductive structures such as conductor tracks on the elastomer object.

In a further embodiment of the process of the invention, the elastomer is selected from the group consisting of polyacrylate, acrylic ester rubber, polyacrylonitrile, poly(acrylonitrile-co-butadiene-co-styrene), poly(acrylonitrile-co-methyl methacrylate), polyamide, polyamideimide, polyester, polyether ether ketone, polyether ester, polyethylene, ethylene-propylene rubber, poly(ethylene-co-tetrafluoroethylene), poly(ethylene-co-vinyl acetate), poly(ethylene-co-vinyl alcohol), fluorosilicones, perfluoroalkoxy polymers, (natural) rubber, poly(methyl methacrylate-co-acrylonitrile-co-butadiene-co-styrene), poly(methyl methacrylate-co-butadiene-co-styrene), nitriles, olefins, polyphosphazenes, polypropylene, poly(methyl methacrylate), polyurethanes, polyvinyl chloride, polyvinyl fluorides and silicones.

In a further embodiment of the process of the invention, the surface layer of the elastomer is, partly covered by a mask at least in step (D). The mask covers subregions of the surface and leaves other regions free. In this way, electrically conductive structures such as conductor tracks and the like can be produced on the elastomer surface.

The elastomer surface obtained according to the invention can, for example, have a specific resistance of the surface layer of from ≧10⁻³ ohm cm to ≦10⁸ ohm cm. The specific resistance can be determined in accordance with the standard ASTM D 257. This resistance is preferably in the range from ≧1 ohm cm to ≦1 000 000 ohm cm, more preferably from ≧10 ohm cm to ≦100 000 ohm cm. The layer thickness required to calculate the specific resistance ρ can be obtained from electron micrographs of a specimen cross section.

The present invention likewise provides an extensible electrode comprising an elastomer having a surface layer which comprises electrically conductive carbon particles and can be obtained by a process according to the invention, wherein the elastomer has a glass transition temperature T_{g} of from ≧−130° C. to ≦0° C. and, furthermore, the stress σ does not decrease with increasing elongation in the elastomer. As regards the elastomers and possible embodiments of the elastomers, reference will be made to what has been said with regard to the process of the invention in order to avoid repetition.

Extensible electrodes according to the invention are, for example, useful in elastomer moldings which are subsequently to be coated by means of electrostatic powder coating or electrophoretic coating or are to be electroplated. Other examples are electronic components in general or cable sheathing having an antistatic coating. Particularly preferred uses are indicated further below.

In an embodiment of the electrode of the invention, the carbon particles are present in the surface layer to a depth of ≦10 μm below the surface.

In calculating the penetration depth, the additional electrically conductive layer is not taken into account. As indicated above, the surface layer comprises an elastomer. The particles in this surface layer advantageously form a network so that electrical conductivity occurs. The particles can also be present up to a depth of ≦5 μm or ≦1 μm below the surface. According to the invention, objects which comprise the elastomer surface layer provided with carbon particles and additionally have further materials are also included. They can be, for example, consumer articles which at least partly comprise an elastomer surface and in which the electrically conductive carbon particles have been introduced into this surface or elastomer surface layer.

In a further embodiment of the electrode of the invention, the carbon particles are present within the elastomer material of the surface layer surrounding them in a proportion of from ≧0.1% by weight to ≦10% by weight. The proportion can also be in the range from ≧0.5% by weight to ≦4% by weight or from ≧1% by weight to ≦5% by weight. The content of carbon particles in the surface layer is ultimately indicated thereby. The boundary of the surface layer in the interior of the object, from which the elastomer material no longer comes into the calculation, is formed by the lowermost (innermost) line up to which the carbon particles occur in the elastomer region. Within the ranges indicated, the percolation limit for the carbon particles can be exceeded, so that the electrical conductivity is greatly improved.

In a further embodiment of the electrode of the invention, the electrode has a specific resistance of the surface layer of from ≧10⁻³ ohm cm to ≦10⁸ ohm cm. The specific resistance can be determined in accordance with the standard ASTM D 257. This resistance is preferably in the range from ≧1 ohm cm to ≦1 000 000 ohm cm, more preferably from ≧10 ohm cm to ≦100 000 ohm cm.

In a further embodiment of the electrode of the invention, the carbon particles are unfunctionalized, multiwall carbon nanotubes having a diameter of from ≧3 nm to ≦100 nm. The diameter is here based on the average diameter of the nanotubes. It can also be in the range from ≧5 nm to ≦80 nm and advantageously from ≧6 nm to ≦60 nm. The length of the nanotubes is initially not limited. However, it can be, for example, in the range from ≧1 μm to ≦100 μm and advantageously from ≧10 μm to ≦30 μm.

In a further embodiment of the electrode of the invention, this has a first and a second surface layer comprising electrically conductive carbon particles, wherein said first and second surface layers are arranged opposite one another and are separated from one another by an elastomer layer. Due to the production process, the first and second surface layers are integrally joined to the separating, electrically insulating elastomer. An elastic capacitor can be realized by means of such a structure of two electrically conductive layers separated by a dielectric. An additional electrically conductive layer as mentioned above is then arranged directly on the first and/or second surface layer.

In a further embodiment of the electrode of the invention, this comprises an additional electrically conductive layer arranged on the surface layer comprising electrically conductive carbon particles, wherein the additional electrically conductive layer breaks up or ruptures on elongation of the surface layer before the latter does.

The additional electric layer can be, for example, a conductive surface coating, a conductive paste, a metal layer or a layer of an electrically conductive polymer. Examples of metals are noble metals, copper and/or tin. The additional electric layer can, without being restricted thereto, have a thickness of from ≧10 nm to ≦50 μm or from ≧20 nm to ≦10 μm. The material of the additional electrically conductive layer is selected so that the additional layer breaks up or ruptures first on elongation of the surface layer. It is advantageous here that the electrical conductivity of the overall system does not break down abruptly due to contact of the broken-up or ruptured coating with the surface layer comprising carbon particles but instead is maintained to a certain degree. In other words, although the power density of an extensible electrode decreases with time as a result of the stress, it does not cease completely. This behavior is particularly advantageous when the elastomer is subjected to cyclic elongation and destressing and electrical conductivity is required over the entire time.

The additional electrically conductive layer preferably comprises gold, silver, copper, indium-tin oxide, fluorine-doped tin(IV) oxide, aluminum-doped zinc oxide, antimony-doped tin(IV) oxide and/or poly(3,4-ethylenedioxythiophene). Gold can, for example, be applied by sputtering. Poly(3,4-ethylenedioxythiophene) is usually referred to as PEDOT or PEDT and can be applied from a preparation of the polymer.

It is possible for the elastomer object according to the invention to be in the form of a composite of a support material with the elastomer surface layer comprising the electrically conductive carbon particles. Examples of support materials are ceramics, metals and also other polymers such as polycarbonates or polyolefins. Thus, for example, a shaped metal part can firstly be coated with the elastomer and the elastomer surface layer can subsequently be provided with the carbon particles and the additional electrically conductive layer.

The invention further provides for the use of an electrode according to the invention as electromechanical transducer, as electromechanical actuator and/or as electromechanical sensor. The elastomer in the electrode is then an electroactive polymer and in particular a dielectric elastomer.

The present invention is illustrated by the following examples in conjunction with the figures. In the figures:

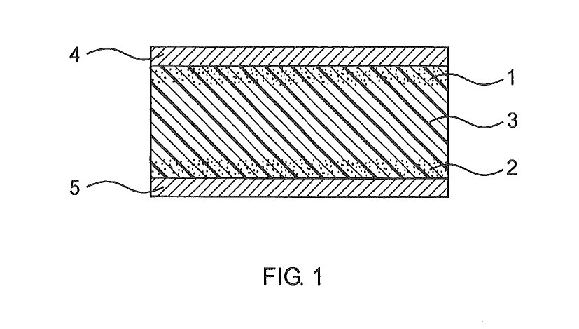

FIG. 1 shows an electrode arrangement having a multilayer structure

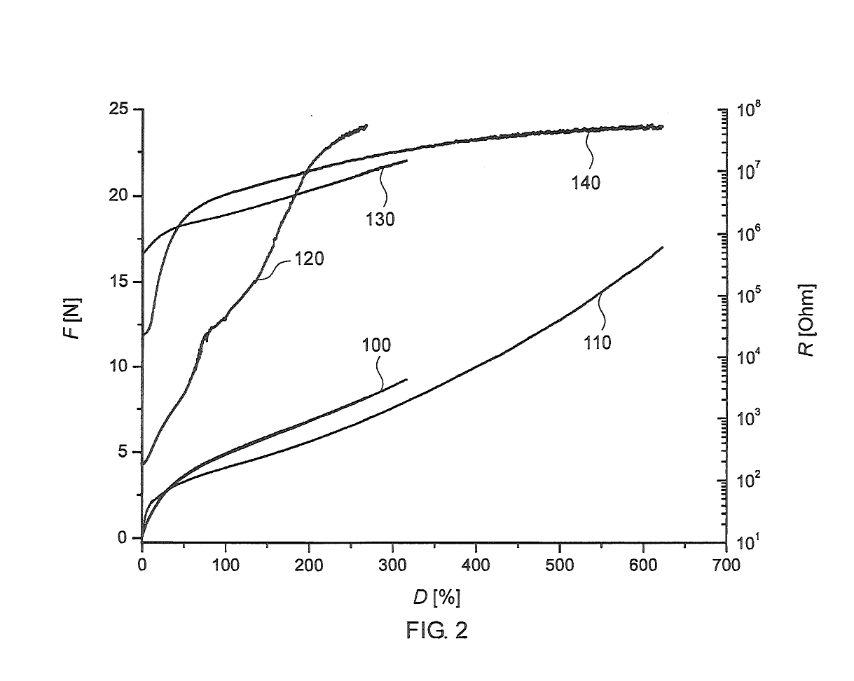

FIGS. 2, 3 and 4 show conductivity measurements during elongation for various elastomer specimens

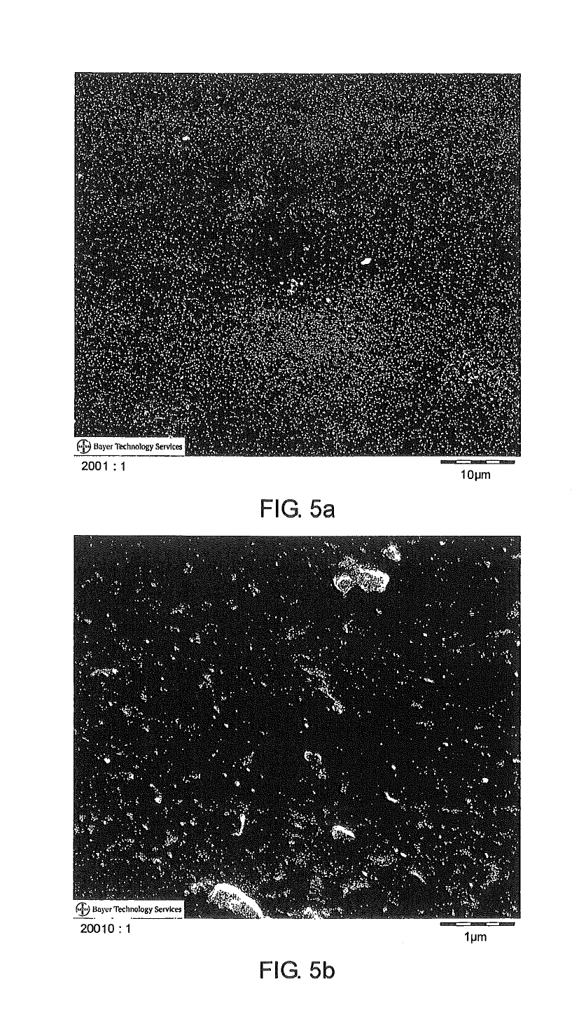

FIGS. 5a, 5b, 6a, 6b, 7a, and 7b show scanning electron micrographs of various elastomer specimens

FIG. 1 schematically shows an electrode arrangement according to the invention having a multilayer structure. Starting out from an elastomer workpiece, carbon particles such as carbon nanotubes were introduced into the upper surface layer (1) and the lower surface layer (2) of the elastomer. These particles are represented by strokes or dots in the respective layers (1, 2). It can be seen that the particles have a limited penetration depth into the surface layers. An additional electrically conductive layer (4, 5) is present on each of the surface layers (1, 2). The surface layers (1, 2) are separated from one another by a particle-free elastomer layer (3). Owing to the production process, the electrode always has a one-piece structure in respect of the surface layers (1, 2) and the surface layers are integrally joined to the particle-free layer (3). The electrodes shown can, given suitable dimensions, serve, for example, as film-like capacitors or as electroactive polymers (EAP).

### EXAMPLES

The examples concern the functionalization of two elastomers E1 and E2. Elastomer E1 was a thermoplastic polyurethane (DESMOPAN® 3380A, from Bayer MaterialScience AG) having a Shore A hardness in accordance with ISO 868 of 80 and a glass transition temperature T_{g} of −35° C. Elastomer E2 was a polyurethane prepared from a prepolymer obtained by preextension of a PO-based polyether polyol (Acclaim® 6300, from Bayer MaterialScience AG) by means of diphenylmethane 4,4′-diisocyanate (Desmodur® 44 M Flakes, from Bayer MaterialScience AG), which was finally crosslinked by means of a polytetramethylene ether glycol (M=2000 g/mol). The glass transition temperature T_{g} of the elastomer E2 was −65° C.

The carbon particles mentioned in the examples were in one case carbon nanotubes (CNT) in the form of multiwall carbon nanotubes having the trade name BAYTUBES® C 150 P from Bayer MaterialScience AG The other type of carbon particles was carbon black in the form of conductive carbon black (Ketjenblack 600).

PEDOT used as coating agent was poly-3,4-ethylenedioxythiophene having the trade name Clevios P® from HCStarck. This was in the form of a preparation containing 0.3% by weight in deionized water.

The dipping solution was produced by sonication of a defined amount of carbon particles in the solvent by means of an ultrasonic probe and used immediately. The frequency of the ultrasound here was 20 kHz and the power density was 300 W/kg.

To functionalize the elastomer surfaces, the specimens were immersed completely in the dipping preparation and treated with ultrasound for a defined time in an ultrasonic bath. After the specimens had been taken from the bath, the surface was briefly rinsed with acetone, dried completely at room temperature and subsequently rubbed down with an aqueous soap solution.

The optional coating of the elastomers which had been CNT-functionalized in this way was carried out in a second step by vapor deposition of gold (Sputter Coater 108auto from Cressington) or dipping for 20 seconds into the abovementioned PEDOT-containing solution. The gold layers applied were opaque and had a metallic shine. A layer thickness of over 10 nm was therefore assumed.

Surface and volume resistances were measured in accordance with the standard ASTM D 257 on the elastomers which had been treated in this way. Furthermore, the surface resistance was measured as a function of the mechanical elongation. Here, rectangular bars for tensile tests analogous to DIN 53504 were stamped from the elastomers and the clamps were equipped with contacts which were conductively joined to the specimen and electrically insulated from the tensile tester. The resistance across the specimen was measured continuously by means of a conventional multimeter from Keithley, model 2400, during the slow-running tensile test, strain rate 1 mm/min, and, in a second step, the force-deformation curve was synchronized with the resistance measurement via the time stamp of the individual measurement.

The experimental conditions and the results obtained are shown in the following tables.

| | | | | | Time of |
|---|---|---|---|---|---|
| | | | | | action of |
| | | | c [% | | preparation |
| Elastomer | Specimen | Filler | by weight] | Solvent | [min] |
| E1 | a | — | 0 | Acetone | 60 |
| E1 | b | CNT | 0.05 | Acetone | 30 |
| E1 | c | Carbon black | 0.05 | Acetone | 10 |
| E1 | d | CNT/ | 0.05/ | Acetone | 10 |
| | | carbon black | 0.05 | | |
| E1 | e | CNT | 0.5 | Acetone | 10 |
| E2 | a | — | 0 | Acetone | 10 |
| E2 | b | CNT | 0.05 | Acetone | 3 |
| E2 | c | Carbon black | 0.05 | Acetone | 3 |
| E2 | d | CNT/ | 0.025/ | Acetone | 3 |
| | | carbon black | 0.025 | | |

| | | | Surface | Specific |
|---|---|---|---|---|
| | | Volume resistance | resistance R | resistance ρ |
| Elastomer | Specimen | [ohm cm] | [ohm/square] | [ohm cm]* |
| E1 | a | 4.0 · 10¹² | 7.3 · 10¹⁴ | 2.2 · 10¹⁰ |
| E1 | b | 4.2 · 10⁸ | 7.7 · 10⁵ | 2.3 · 10¹ |
| E1 | c | 2.6 · 10⁸ | 1.7 · 10⁶ | 5.1 · 10¹ |
| E1 | d | 2.8 · 10⁸ | 1.3 · 10⁶ | 3.9 · 10¹ |
| E1 | e | 2.9 · 10⁸ | 3.9 · 10⁵ | 1.2 · 10¹ |
| E2 | a | 1.9 · 10¹¹ | 8.0 · 10¹³ | 2.4 · 10⁹ |
| E2 | b | 3.6 · 10⁹ | 7.6 · 10⁶ | 2.3 · 10² |
| E2 | c | 5.7 · 10⁸ | 4.2 · 10⁵ | 1.3 · 10¹ |
| E2 | d | 3.5 · 10⁸ | 3.6 · 10⁵ | 1.1 · 10¹ |

*specific resistance of the surface layer; calculated according to ρ = R · d with a layer thickness d = 0.3 μm

The result of these experiments are shown in FIGS. 2, 3 and 4.

FIG. 2 shows the dependence of the force F (left-hand y axis) or the resistance of the tensile bar of the specimen R (right-hand y axis) on the elongation E (x axis) for various variants of the elastomer E1e. The measured curves 100 and 110 relate to the force during deformation. Curve 100 is a superimposition of two curves which are virtually identical. One of these curves relates to the elastomer specimen E1e without a further coating, while the other relates to the elastomer specimen E1e with a gold layer. The measurement for the gold-coated specimen E1e was stopped at an elongation of about 275%, as can be seen from the reduced thickness of the curve 100 above this elongation. The shape of these curves indicates that the additional gold layer has no influence on the mechanical properties of the elastomer. The measured curve 110 relates to a specimen of the elastomer E1e with an additional PEDOT layer.

Curves 120, 130 and 140 indicate the resistance R as a function of the deformation D for various specimens of the elastomer E1e. The curve 120 relates to a gold-coated specimen. Here too, the measurement was stopped at an elongation of about 275%. Curve 130 relates to an elastomer E1e without a further coating. Finally, curve 140 relates to a PEDOT-coated specimen of the elastomer E1e. It can clearly be seen that elastomer E1e has a conductivity which does not disappear under deformation and can be significantly improved further by means of an additional, conductive surface layer in certain deformation ranges.

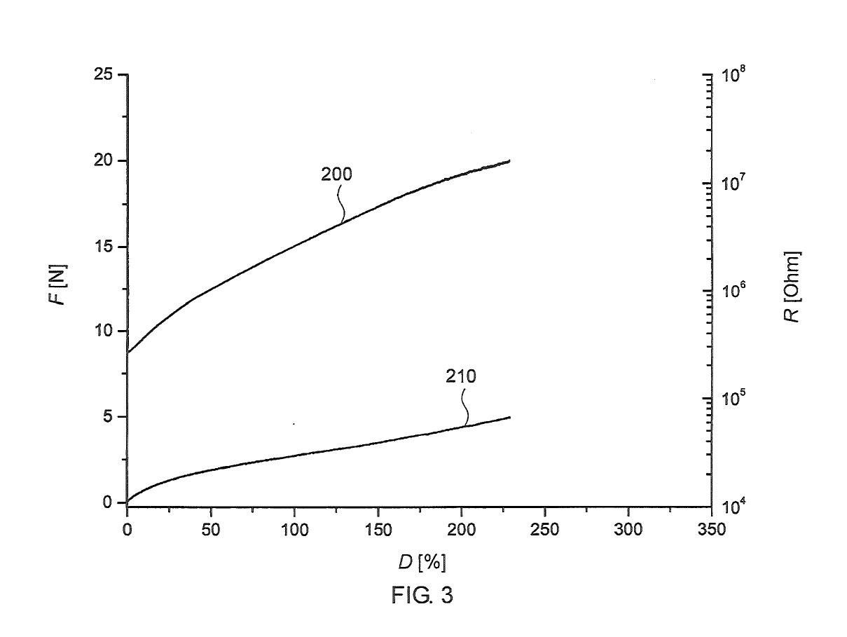

FIG. 3 again shows the dependence of the force F (left-hand y axis) for the elastomer E1e in measured curve 210. A rough estimate indicates that the resistance is increased by about two powers of ten in the measured elongation range of about 230%.

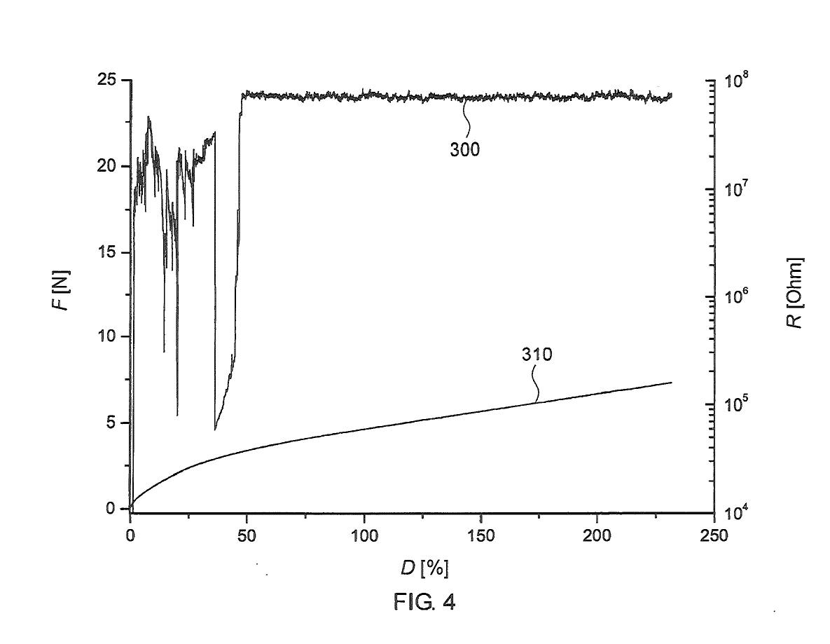

FIG. 4 relates to an untreated specimen which had not been functionalized with carbon particles of the elastomer E1 which had also not been dipped in acetone (as would be the case for a specimen denoted as E1a). The figure shows the dependence of the force F (left-hand y axis) in measured curve 310 or the resistance R (right-hand y axis) in measured curve 300 on the elongation E (x axis) for a specimen of the elastomer E1 which had been sputtered with gold on both sides. Without a CNT layer introduced into the elastomer, the conductivity of the gold-sputtered specimen breaks down on deformation even at small deformations.

FIGS. 5a, 5b, 6a, 6b, 7a and 7b show scanning electron micrographs (SEM) of various specimens according to the invention. They were produced by means of an SEM model ESEM Quanta 400 from FEI.

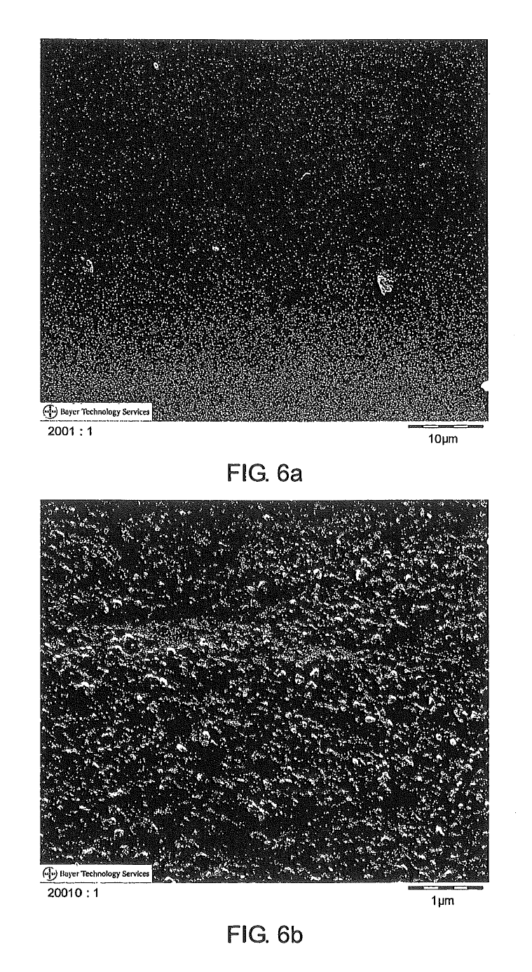

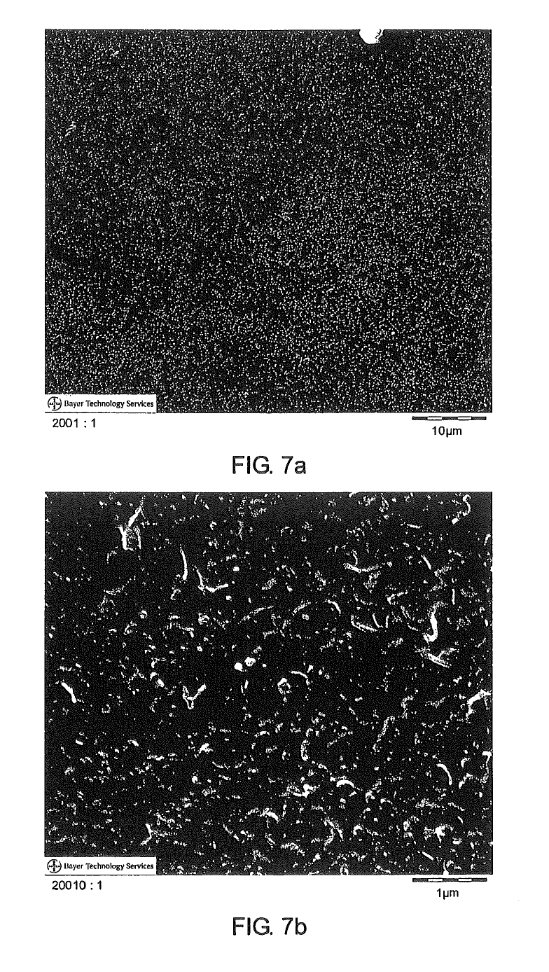

FIG. 5a shows a scanning electron micrograph of the surface of a specimen of the elastomer E2b. An enlarged micrograph of this specimen is shown in FIG. 5b. FIG. 6a shows a scanning electron micrograph of the surface of a specimen of the elastomer E2c and FIG. 6b shows an enlarged micrograph of this specimen. Correspondingly, FIG. 7a shows a scanning electron micrograph of the surface of a specimen of the elastomer E2d and FIG. 7b shows an enlarged scanning electron micrograph of this specimen.

It can be seen in the scanning electron micrographs that the particles, i.e. carbon nanotubes and/or carbon black particles, are embedded in the polymer matrix and enclosed therein. The surfaces show at most a relief structure caused by the particles. Only occasionally do loose nanotube ends project from the polymer matrix. Overall, the particles were thus incorporated firmly into the polymer surface.

1-15. (canceled)

16. A process for producing extensible electrodes having a surface layer comprising electrically conductive carbon particles, which comprises the steps:
(A) provision of an elastomer which has a glass transition temperature T_{g} of from ≧−130° C. to ≦0° C. and in which the stress σ does not decrease with increasing elongation;
(B) provision of a preparation of unaggregated carbon particles having an average particle diameter of from ≧0.3 nm to ≧3000 nm in a solvent which is able to bring about swelling of a surface layer of the elastomer;
(C) contacting of the surface layer of the elastomer with the preparation of the carbon particles;
(D) acting of the preparation of the carbon particles on the surface layer of the elastomer for a time which is insufficient to bring the elastomer into solution; and
(E) ending of the action of the preparation of the carbon particles on the surface layer of the elastomer.

17. The process as claimed in claim 16, which further comprises the step:
(F) application of an additional electrically conductive layer to the surface layer comprising electrically conductive carbon particles obtained in steps (B) to (E), where the additional electrically conductive layer obtained breaks up or ruptures on elongation of the surface layer before the latter does.

18. The process as claimed in claim 16, wherein the acting of the preparation of the carbon particles on the surface layer of the elastomer in step (D) takes place using ultrasound and/or heat.

19. The process as claimed in claim 16, wherein the carbon particles are selected from the group consisting of carbon nanotubes, single-wall carbon nanotubes, multiwall carbon nanotubes, carbon nanohorns, carbon nanoonions, fullerenes, graphite, graphene, carbon fibers, carbon black and/or conductive carbon black.

20. The process as claimed in claim 16, wherein the solvent is selected from the group consisting of methanol, ethanol, isopropanol, butanol, ethylene glycol, propylene glycol, butylene glycol, glycerol, hydroquinone, acetone, ethyl acetate, trichloroethylene, trichloroethane, trichloromethane, methylene chloride, cyclohexanone, N,N-dimethylformamide, dimethyl sulfoxide, tetrahydrofuran, N-methyl-2-pyrrolidone, benzene, toluene, chlorobenzene, styrene, polyester polyols, polyether polyols, methyl ethyl ketone, ethylene glycol monobutyl ether, diethylene glycol, mixtures of the abovementioned solvents with one another and mixtures of the abovementioned solvents with water.

21. The process as claimed in claim 16, wherein the elastomer is selected from the group consisting of polyacrylate, acrylic ester rubber, polyacrylonitrile, poly(acrylonitrile-co-butadiene-co-styrene), poly(acrylonitrile-co-methyl methacrylate), polyamide, polyamideimide, polyester, polyether ether ketone, polyether ester, polyethylene, ethylene-propylene rubber, poly(ethylene-co-tetrafluoroethylene), poly(ethylene-co-vinyl acetate), poly(ethylene-co-vinyl alcohol), fluorosilicones, perfluoroalkoxy polymers, (natural) rubber, poly(methyl methacrylate-co-acrylonitrile-co-butadiene-co-styrene), poly(methyl methacrylate-co-butadiene-co-styrene), nitriles, olefins, polyphosphazenes, polypropylene, poly(methyl methacrylate), polyurethanes, polyvinyl chloride, polyvinyl fluorides and silicones.

22. The process as claimed in claim 16, wherein the surface layer of the elastomer is partly covered by a mask, at least in step (D).

23. An extensible electrode comprising an elastomer having a surface layer (1) which comprises electrically conductive carbon particles and can be obtained by a process as claimed in claim 16, wherein the elastomer has a glass transition temperature T_{g} of from ≧−130° C. to ≦0° C. and, furthermore, the stress σ does not decrease with increasing elongation in the elastomer.

24. The electrode as claimed in claim 23, wherein the carbon particles are present in the surface layer (1) to a depth of ≦10 μm below the surface.

25. The electrode as claimed in claim 23, wherein the carbon particles are present within the elastomer material of the surface layer (1) surrounding them in a proportion of from ≧0.1% by weight to ≦10% by weight.

26. The electrode as claimed in claim 23 having a specific resistance to the surface layer (1) of from ≧10⁻³ ohm cm to ≦10⁸ ohm cm.

27. The electrode as claimed in claim 23 having a first (1) and a second (2) surface layer comprising electrically conductive carbon particles, wherein said first (1) and second (2) surface layers are arranged opposite one another and are separated from one another by an elastomer layer (3).

28. The electrode as claimed in claim 23 which further comprises an additional electrically conductive layer (4) arranged on the surface layer (1) comprising electrically conductive carbon particles, where the additional electrically conductive layer (4) breaks up or ruptures on elongation of the surface layer (1) before the latter does.

29. The electrode as claimed in claim 28, wherein the additional electrically conductive layer (4) comprises gold, silver, copper, indium-tin oxide, fluorine-doped tin(IV) oxide, aluminum-doped zinc oxide, antimony-doped tin(IV) oxide and/or poly(3,4-ethylenedioxythiophene).

30. The use of an electrode as claimed in claim 23 as electromechanical transducer, as electromechanical actuator and/or as electromechanical sensor.
